(19) United States
(12) Patent Application Publication
(10) Pub. No.: US 2008/0185414 A1
(43) Pub. Date: Aug. 7, 2008

(54) Tool pouch with magnets

(76) Inventor: Jonathan Eric Conlon, Yukon, OK (US)

Correspondence Address: DUNLAP CODDING & ROGERS, P.C., PO BOX 16370, OKLAHOMA CITY, OK, 73113, US

(21) Appl. No.: 12/012,546

(22) Filed: Feb. 4, 2008

Related U.S. Application Data
(60) Provisional application No. 60/899,259, filed on Feb. 2, 2007.

(51) Int. Cl. A45F 5/00; B65D 85/24; B25H 3/00

(52) U.S. Cl. 224/674; 206/338; 206/349; 383/33

(57) ABSTRACT

A tool pouch for holding nails, fasteners and other items has a front section and a back section forming a pocket defining an open cavity. A magnetic assembly is attached to the pocket front section, and a second magnetic assembly is attached to the pocket back section. The magnetic assemblies are aligned such that the first magnetic assembly repels the second magnetic assembly. The positioning and the magnetic strength of the first and second magnetic assemblies are sufficient to bias the opening of the first pocket toward an open position.

### CROSS REFERENCE TO RELATED APPLICATIONS

This application claims the benefit under 35 U.S.C. 119(e) of U.S. Provisional Application Ser. No. 60/899,259, filed Feb. 2, 2007, the contents of which are hereby expressly incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates generally to pouches and, more particularly, to a tool pouch having opposing magnetic members positioned on front and back portions of a pocket of the pouch to secure magnetically responsive items within the pouch and to maintain the pocket in an open position.

2. Brief Description of the Prior Art

It is known that the primary function of a pocket in a tool or nail pouch is to hold nails, screws and other fasteners in a location where the user can obtain easy access to them. The tool or nail pouch is usually suspended from a work belt so the user can readily transport items such as nails and fasteners without using his or her hands.

Conventional tool pouches consist of one or more pockets or openings so that nails, screws, or other fasteners can be placed where the user may obtain easy access when needed. To allow ready access, the pockets are typically not closed, and this often leads to inadvertent spilling of the fasteners when the wearer causes the pouch to move from an upright position. Conventional pouches also do not easily maintain an upright position when not worn, making it difficult to transport a pouch containing fasteners to the job without wearing it. Also, conventional tool pouch pockets often do not remain open to allow easy access unless the pocket is made of a very stiff, and often expensive, material.

Thus, it would be advantageous to have a tool pouch which could be made to rest in an upright position and for which the pockets would remain open, allow ready access to fasteners within the pockets, and still minimize spillage.

### SUMMARY OF THE INVENTION

The present invention is directed to a tool pouch for holding nails, fasteners and other items. The pouch has a front section and a back section forming a first pocket defining an open cavity. A first magnetic assembly is attached to the first pocket back section, and a second magnetic assembly is attached to the first pocket front section. The magnetic assemblies are aligned such that the first magnetic assembly repels the second magnetic assembly. The positioning and the magnetic strength of the first and second magnetic assemblies are sufficient to bias the opening of the first pocket toward an open position. In addition, the positioning and the magnetic strength of the first and second magnetic assemblies are sufficient to bias magnetically susceptible items such as nails and screws within the first pocket cavity toward the first pocket cavity and away from the first cavity pocket opening.

A tool belt is also provided wherein the tool belt includes a tool pouch, a tool belt loop on the top side of the tool pouch, and a belt for fitting about the waist of a person, wherein the belt is fitted through the tool belt loop to support the tool pouch suspended thereon. The tool pouch includes a first pocket having a front section and a back section, wherein the first pocket defines an open cavity. A first magnetic assembly is attached to the first pocket back section, and a second magnetic assembly is attached to the first pocket front section. The magnetic assemblies are aligned such that the first magnetic assembly repels the second magnetic assembly. The positioning and the magnetic strength of the first and second magnetic assemblies are sufficient to bias the opening of the first pocket toward an open position, and can retain magnetically susceptible items such as nails and screws within the first pocket cavity.

Other features and advantages of the present invention will be readily apparent to those skilled in the art upon a reading of the description of preferred embodiments which follows when taken in conjunction with the accompanying drawings.

### BRIEF DESCRIPTION OF THE DRAWINGS

FIG. 1 is a simplified representation of the front of a tool pouch constructed in accordance with an embodiment of the present invention.

FIG. 2 is a simplified representation of the side of a tool belt and tool pouch constructed in accordance with an embodiment of the present invention.

FIGS. 3A and 3B are simplified representations of a tool pouch constructed in accordance with an embodiment of the present invention and showing placement of the magnetic assemblies.

FIG. 4 is a simplified representation of a tool pouch constructed in accordance with an embodiment of the present invention and showing placement of magnets within magnet pouches.

### DESCRIPTION OF THE PREFERRED EMBODIMENTS

Before explaining the invention in detail, it is to be understood that the invention is not limited in its application to the details of construction, exemplary data, and/or the arrangement of the components set forth in the following description or illustrated in the drawings. The invention is capable of other embodiments or of being practiced or carried out in various ways. Also, it is to be understood that the phraseology and terminology employed herein is for purpose of description and should not be regarded as limiting.

The tool pouch 10 of the present invention helps eliminate the potential for the pouch contents, such as nails, fasteners, and other magnetically susceptible items 30, to fall out due to abnormal positioning, such as can occur when the tool belt is worn by a person climbing up a ladder. The inventive design additionally helps keep a first pocket 14 of the tool pouch 10 open for ready access while minimizing or eliminating spillage. It also provides means to maintain the tool pouch 10 in an upright position to prevent the contents from falling out when the tool pouch 10 is not in use.

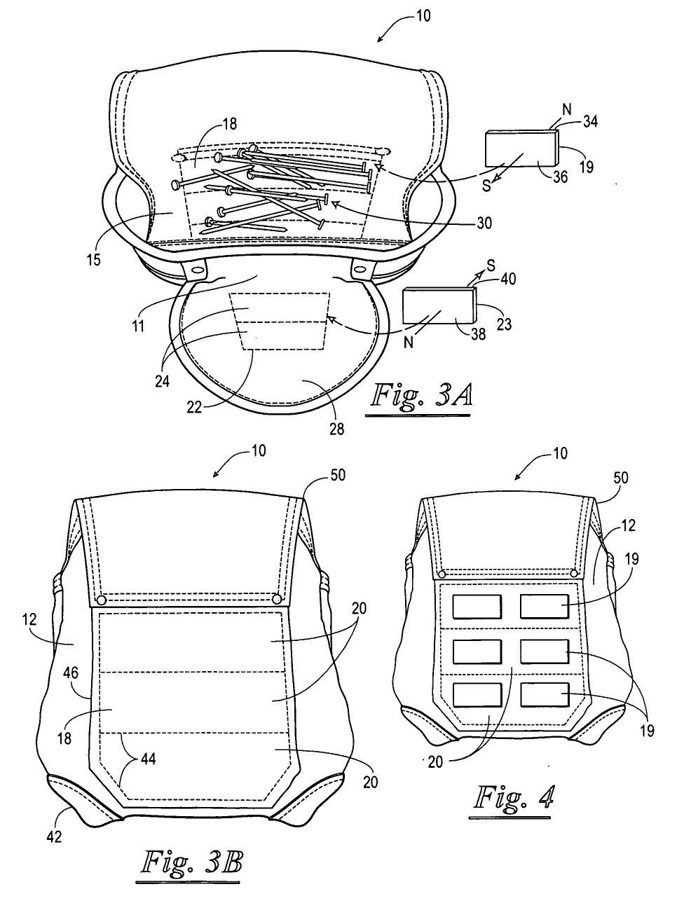

Referring now to FIGS. 1, 2 and 3A, a tool pouch 10 has a first pocket 14 defining a first cavity 15 having an opening 13. A first magnetic assembly 18 is attached to a back section 12 of the first pocket 14, and a second magnetic assembly 22 is attached to a front section 11 of the first pocket 14. The first magnetic assembly 18 and the second magnetic assembly 22 (sometimes referred to collectively herein as magnetic assemblies 18 and 22) are aligned such that the first magnetic assembly 18 repels the second magnetic assembly 22 and vice versa. For example and as shown in FIG. 3A, the south face 36 of magnet 19 in the first magnetic assembly 18 faces, and is repelled by, the south face 40 of magnet 23 in the second magnetic assembly 22. Alternatively, the north face 34 of magnet 19 in the first magnetic assembly 18 could face, and be repelled by, the north face 38 of magnet 23 in the second magnetic assembly 22. The positioning and the magnetic strength of the first and second magnetic assemblies 18 and 22 are sufficient to bias the opening 13 of the first pocket toward an open position.

The magnetic assemblies 18 and 22 can each include one or more individual permanent magnets such as magnets 19 and 23 and known to those skilled in the art. Non-limiting examples of suitable magnet types include metallic, ceramic, composite and rare-earth magnets. For example, rare-earth Neodymium-Iron-Boron (NdFeB) block or disc magnets available commercially from National Imports LLC of Vienna, Va., can be utilized. Two single magnets can be used, or multiple magnets. For example, three NdFeB block magnets having a size of 2 in×0.5 in×0.125 in and a pull force of 12 lb/5470 g can be utilized on a single side.

The individual permanent magnets can be shaped in block, disc or other shapes. For example, the magnets can be thin rectangular blocks having a magnetic field directed perpendicular to the rectangular faces of the magnets. The individual magnets can be glued or fastened by other means known to those skilled in the art, or can be positioned within magnet cavities or pouches. For example and as shown in FIGS. 3A, 3B and FIG. 4, magnets can be positioned within magnet cavities or pouches 24 attached to the first pocket front section 11, and additional magnets can be positioned within magnet cavities or pouches 20 attached to the first pocket back section 12. Front section 11 and back section 12 can each have single or, preferably, a section of magnets positioned within magnet pouch 24 and magnetic pouch 20. Positioning can be away from the top opening 13 and the bottom of the first pocket 14 to provide a midsection that is magnetized. Such location helps to secure the contents (magnetically susceptible items 30) within the cavity 15 of the first pocket 14 and helps prevent unnecessary spillage.

It is not necessary for magnetic assembly 18 to match or mirror image magnetic assembly 22. In some instances, it may be desirable to have a greater magnetic force on the first pocket back section 12, compared to the first pocket front section 11, to make the pouch more magnetically supportable on a metal surface. The first magnetic assembly 18 provides the pouch with the ability to be attached to a metal surface in order to keep the pouch in an upright position. The pouch can be held upright by attaching to, for example, a metal file cabinet, or to the vertical side of a truck bed or tool chest, such that the contents will not spill while traveling to a job.

While non-metal magnets do not rust, they are breakable. Therefore, actual size and number of non-metal magnets should be chosen to minimize breakage and to optimize the magnetic strength required to reduce or eliminate spillage and to hold the pouch upright on a vertical metal surface.

The tool pouch 10 can include a second pocket 16 attached to the first pocket 14 by, for example, rivets 17, stitching, or the like. When dealing with more than one type of fastener, the second pocket 16 and/or additional pockets (not shown) are available to provide a proper place for easy organized access to the other types of fasteners. The back 33 of the second pocket 16 can be either attached to, or continuous with, the first pocket front section 11. Optionally, a magnetic assembly can be similarly positioned on the front 32 of the second pocket 16 to maintain the second pocket in an open position and to secure the magnetically susceptible contents of the second pocket within the cavity of the second pocket 16 to help prevent unnecessary spillage.

The pouch can be made of any suitable material and known to those skilled in the art. Non-limiting examples of materials include leather, nylon, canvas, polyester, and the like. The pouch can be constructed with seams 44 or other means known to those skilled in the art. Reinforced corners 42 can also be provided.

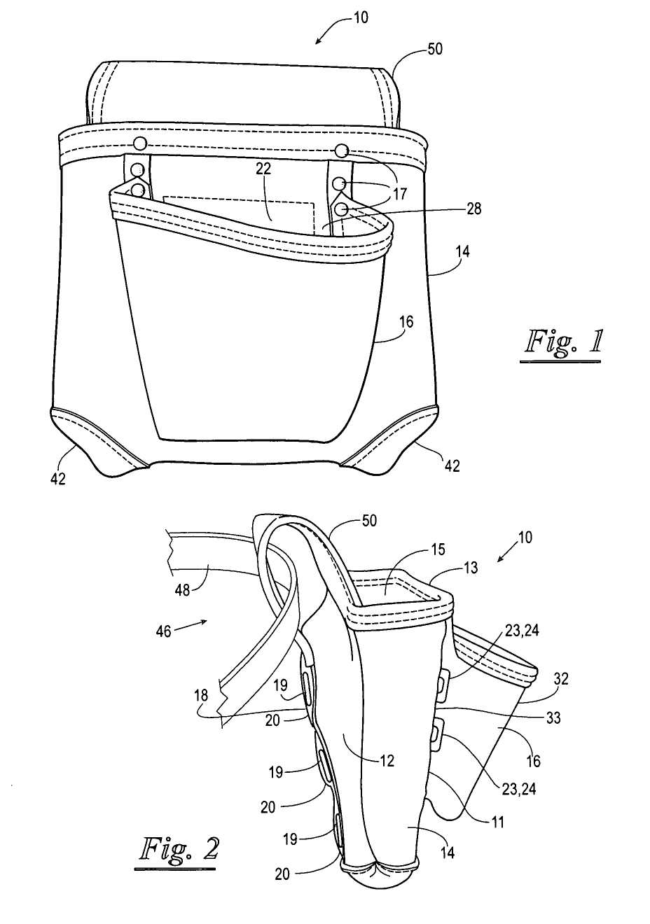

Also, a tool belt 46 is provided wherein a tool belt loop 50 is included on the tool pouch 10. A belt 48 for fitting about the waist of a person is fitted through the tool belt loop 50 to support the tool pouch 10 in a suspended manner. A “tool belt loop” is herein defined to include a loop as shown in FIG. 2, slits in the tool pouch through which a belt can be threaded, and any other means for attaching a belt to a pouch known to those skilled in the art.

While the drawings and descriptions refer to a two-pocket nail pouch, it is understood that the invention includes pouches with single and with multiple pockets and that the pouch can be used to carry magnetically susceptible items 30 such as screws, bolts, staples, and other fasteners.

From the above description, it is clear that the presently disclosed and claimed inventive process(es), methodology(ies), apparatus(es) and composition(s) are well adapted to carry out the objects and to attain the advantages mentioned herein as well as those inherent in the presently provided disclosure. While presently preferred embodiments of the inventive process(es), methodology(ies), apparatus(es) and composition(s) have been described for purposes of this disclosure, it will be understood that numerous changes may be made which will readily suggest themselves to those skilled in the art, and such changes are encompassed within the spirit of the presently disclosed and claimed inventive process(es), methodology(ies), apparatus(es) and composition(s) described herein.

What is claimed is:

1. A pouch for a tool belt comprising:
a first pocket defining a first cavity, the first cavity including a first opening, the first pocket including a front section and a back section; and
a first magnetic assembly attached to the first pocket back section and a second magnetic assembly attached to the first pocket front section, wherein the first and second magnetic assemblies are aligned to repel each other, the magnetic strength of the first and second magnetic assemblies being sufficient to bias the first opening toward an open position.

2. The pouch of claim 1 wherein the magnetic strength and positioning of the first and second magnetic assemblies are sufficient to bias magnetically susceptible items within the first pocket cavity toward the first pocket cavity and away from the first pocket cavity opening.

3. The pouch of claim 1 wherein the magnetic strength and positioning of the first and second magnetic assemblies are sufficient to retain nails within the first pocket cavity.

4. The pouch of claim 1 wherein the strength of the first magnetic assembly attached to the first pocket back section is sufficient to hold the pouch in an upright position against a magnetically susceptible surface.

5. The pouch of claim 1 wherein each first and second magnetic assembly comprises one or more magnets.

6. The pouch of claim 5 wherein the magnet(s) of the first magnetic assembly is retained in a pouch(es) stitched into the first pocket back section and the magnet(s) of the second magnetic assembly is retained in a pouch(es) stitched into the first pocket front section.

7. The pouch of claim 5 wherein the magnet(s) of the first magnetic assembly is adhesively attached to the first pocket back section, and the magnet(s) of the second magnetic assembly is adhesively attached to the first pocket front section.

8. The pouch of claim 1 further comprising a belt loop for fitting a belt therethrough to support the pouch.

9. The pouch of claim 1 further comprising a second pocket defining a second cavity, the second cavity including an opening, the second pocket having a back section attached to or integral with the first pocket front section.

10. The pouch of claim 9 wherein the magnetic strength and positioning of the second magnetic assembly is sufficient to bias magnetically susceptible items within the second pocket cavity toward the interior of the second pocket cavity and away from the second cavity opening.

11. The pouch of claim 9 wherein the magnetic strength and positioning of the second magnetic assembly is sufficient to retain nails within the second pocket cavity.

12. A tool belt comprising:
a tool pouch having a first pocket, the first pocket defining a first cavity having a first opening, the first pocket including a front section and a back section, a first magnetic assembly attached to the first pocket back section and a second magnetic assembly attached to the first pocket back section, wherein the first and second magnetic assemblies are aligned to repel each other, the magnetic strength of the first and second magnetic assemblies being sufficient to bias the first opening toward an open position;
a tool belt loop on a top side of the tool pouch;
a belt for fitting about the waist of a person, the belt fitted through the tool belt loop for support of the tool pouch suspended thereon.

13. The tool belt of claim 12 wherein the magnetic strength and positioning of the first and second magnetic assemblies are sufficient to bias magnetically susceptible items within the first pocket cavity toward the first pocket cavity and away from the first pocket cavity opening.

14. The tool belt of claim 12 wherein the magnetic strength and positioning of the first and second magnetic assemblies are sufficient to retain nails within the first pocket cavity.

15. The tool belt of claim 12 further comprising a second pocket defining a second cavity, the second cavity including an opening, the second pocket having a back section attached to or integral with the first pocket front section.

16. The tool belt of claim 15 wherein the magnetic strength and positioning of the first magnetic assembly is sufficient to bias magnetically susceptible items within the second pocket cavity and away from the second pocket cavity opening.

17. The tool belt of claim 15 wherein the magnetic strength and positioning of the first magnetic assembly are sufficient to retain nails within the second pocket cavity.
